(19) United States
(12) Patent Application Publication
(10) Pub. No.: US 2020/0286039 A1
(43) Pub. Date: Sep. 10, 2020

(54) INFORMATION GENERATION METHOD AND APPARATUS

(71) Applicants: Beijing Jingdong Shangke Information Technology Co., Ltd., Beijing (CN); Beijing Jingdong Century Trading Co., Ltd., Beijing (CN)

(72) Inventor: Yu FAN, Beijing (CN)

(21) Appl. No.: 16/753,765

(22) PCT Filed: Sep. 30, 2018
(86) PCT No.: PCT/CN2018/109122

§ 371 Date: Apr. 4, 2020

(30) Foreign Application Priority Data
Nov. 20, 2017 (CN) 201711156281.X

(51) Int. Cl. G06Q 10/08; G06K 9/62

(52) U.S. Cl. CPC G06Q 10/08355; G06K 9/6218; G06Q 10/087

(57) ABSTRACT

Method and apparatus for generating information are provided. The method may include: obtaining order information to be delivered, the order information including delivery address information; determining coordinates of addresses indicated by the delivery address information, and clustering the order information according to the coordinates to generate clusters: and using center point coordinates in the various clusters matching coordinates of a preconfigured address as starting coordinates of a path, and performing the following path planning steps: using center point coordinates in the remaining clusters having the shortest distance from the starting coordinates as second coordinates of the path; determining whether the number of the remaining clusters reaches a preset threshold; in response to a determination result Yes, generating information used for indicating a delivery path; and in response to a determination result No, using the second coordinates as the starting coordinates, and performing the path planning steps.

### CROSS-REFERENCE TO RELATED APPLICATIONS

This patent application claims the priority of Chinese Application. No. 201711156281.X, filed on Nov. 20, 2017 by Beijing Jingdong Shangke Information Technology Co., Ltd. and Beijing Jingdong Century Trading Co., Ltd., and entitled “Information. Generation Method and Apparatus,” the entire disclosure of which is hereby incorporated by reference.

### TECHNICAL FIELD

Embodiments of the present disclosure relate to the field of computer technology, specifically to the field of Internet technology, and particularly to a method and apparatus for generating information.

### BACKGROUND

Delivery refers to a logistics activity within a range of economically reasonable areas that picking, processing, packaging, dividing, assembling and other operations are performed on items according to the requirements of a customer and the items are punctually delivered to a designated place. The delivery is a special and comprehensive activity form in the logistics, and is a form in which the product flow and the logistics are closely combined and which includes a product flow activity and a logistics activity and also includes several functional elements in the logistics.

### SUMMARY

Embodiments of the present disclosure propose a method and apparatus for generating information.

In a first aspect, an embodiment of the present disclosure provides a method for generating information, including: acquiring to-be-delivered order information, the order information including delivery address information; ascertaining coordinates of an address indicated by the delivery address information, and clustering the order information according to the coordinates to generate a cluster; using center point coordinates matching coordinates of a preset address and being in each cluster as starting coordinates of a path, and performing following path planning: using center point coordinates having a shortest distance from the starting coordinates and being in remaining clusters as second coordinates of the path, the remaining clusters referring to clusters other than a cluster with center point coordinates as coordinates of the path in all clusters; determining whether a number of the remaining clusters reaches a preset threshold; and generating, in response to a determination result being yes, information for indicating a delivery path; and using, in response to the determination result being no, the second coordinates as the starting coordinates, and performing the path planning.

In some embodiments, the coordinates refer to longitude and latitude coordinates, and the clustering the order information according to the coordinates includes: clustering the order information according to a distance between two pairs of coordinates, the distance being a sum of an absolute value of a longitude coordinate difference between the two pairs of coordinates, and an absolute value of a latitude coordinate difference between the two pairs of coordinates.

In some embodiments, when there are at least two clusters having the shortest distance from the starting coordinates in the remaining clusters, the method further includes: using respectively center point coordinates of the at least two clusters as the second coordinates of the path, and performing the path planning, to generate at least two pieces of information for indicating a candidate delivery path; and selecting information from the at least two pieces of information for indicating the candidate delivery path, for use as the information for indicating the delivery path.

In some embodiments, the method further includes: calculating an interval time length between two adjacent coordinate points in the path according to pre-stored historical delivery data, the historical delivery data including coordinate information collected during a delivery and time at which the coordinate information is collected.

In some embodiments, the order information further includes at least one of: commodity information, transaction information or delivery approach information, and the method further includes: ascertaining total order information of the each cluster according to each piece of order information in each cluster; and ascertaining a delivery time length for a coordinate point in a path corresponding to center point coordinates of the each cluster, according to the total order information of the each cluster.

In some embodiments, the method further includes: acquiring departure time from the preset address; ascertaining estimated arrival time for each coordinate point in the path according to the departure time, the interval time length and the delivery time length; and generating information for indicating a delivery path containing the estimated arrival time.

In some embodiments, the order information further includes target delivery arrival time, and the method further includes: ascertaining a coordinate point in a path corresponding to a cluster to which order information including the target delivery arrival time belongs as an adjustment coordinate point; deleting information of the adjustment coordinate point in the information for indicating the delivery path containing the estimated arrival time, and generating a to-be-adjusted path; using the target delivery arrival time as arrival time for a corresponding adjustment coordinate point, and sorting the adjustment coordinate point according to a sequence of the arrival time to generate an adjustment coordinate point list; comparing arrival time for adjustment coordinate points in the adjustment coordinate point list with estimated arrival time for coordinate points in the to-be-adjusted path one by one; and setting, if arrival time for an adjustment coordinate point is earlier than estimated arrival time for a coordinate point, the adjustment coordinate point to be a previous coordinate point of the coordinate point, adjusting the estimated arrival time for the coordinate point and estimated arrival time for next coordinate points of the coordinate point according to the arrival time for the adjustment coordinate point, comparing arrival time for next adjustment coordinate points of the adjustment coordinate point with the adjusted estimated arrival time for the coordinate point and the adjusted estimated arrival time for the next coordinate points of the coordinate point one by one until all adjustment coordinate points in the adjustment coordinate point list are set to be coordinate points in the to-be-adjusted path, and generating information for indicating an adjusted delivery path.

In some embodiments, when a given cluster contains at least two pieces of order information including the target delivery arrival time, the using the target delivery arrival time as arrival time for a corresponding adjustment coordinate point includes: selecting earliest target delivery arrival time from the at least two pieces or order information, for use as arrival time for an adjustment coordinate point corresponding to the cluster to which the order information belongs.

In a second aspect, an embodiment of the present disclosure provides an apparatus for generating information, including: a first acquiring unit, configured to acquire to-be-delivered order information, the order information including delivery address information; a clustering unit, configured to ascertain coordinates of an address indicated by the delivery address information, and cluster the order information according to the coordinates to generate a cluster; a first performing unit, configured to use center point coordinates matching coordinates of a preset address and being in each cluster as starting coordinates of a path, and perform following path planning: using center point coordinates having a shortest distance from the starting coordinates and being in remaining clusters as second coordinates of the path, the remaining clusters referring to clusters other than a cluster with center point coordinates as coordinates of the path in all clusters; determining whether a number of the remaining clusters reaches a preset threshold; and generating, in response to a determination result being yes, information for indicating a delivery path; and a responding unit, configured to use, in response to the determination result being no, the second coordinates as the starting coordinates, and perform the path planning steps.

In some embodiments, the coordinates refer to longitude and latitude coordinates, and the clustering unit is further configured to: cluster the order information according to a distance between two pairs of coordinates, the distance being a sum of an absolute value of a longitude coordinate difference between the two pairs of coordinates, and an absolute value of a latitude coordinate difference between the two pairs of coordinates.

In some embodiments, when there are at least two clusters having the shortest distance from the starting coordinates in the remaining clusters, the apparatus further includes: a second performing unit, configured to respectively use center point coordinates of the at least two clusters as the second coordinates of the path, and perform the path planning, to generate at least two pieces of information for indicating a candidate delivery path; and a selecting unit, configured to select information from the at least two pieces of information for indicating the candidate delivery path, to use the information as the information for indicating the delivery path.

In some embodiments, the apparatus further includes: a first calculating unit, configured to calculate an interval time length between two adjacent coordinate points in the path according to pre-stored historical delivery data, the historical delivery data including coordinate information collected during a delivery and time at which the coordinate information is collected.

In some embodiments, the order information further includes at least one of: commodity information, transaction information or delivery method information. The apparatus further includes: a second calculating unit, configured to ascertain total order information of the each cluster according to each piece of order information in the each cluster; and a third calculating unit, configured to ascertain a delivery time length for a coordinate point in a path corresponding to center point coordinates of the each cluster, according to the total order information of the each cluster.

In some embodiments, the apparatus is further configured to: acquire departure time from the preset address; ascertain estimated arrival time for each coordinate point in the path according to the departure time, the interval time length and the delivery time length; and generate information for indicating a delivery path containing the estimated arrival time.

In some embodiments, the order information further includes target delivery arrival time. The apparatus is further configured to: ascertain a coordinate point in a path corresponding to a cluster to which order information including the target delivery arrival time belongs as an adjustment coordinate point; delete information of the adjustment coordinate point in the information for indicating the delivery path containing the estimated arrival time, and generate a to-be-adjusted path; use the target delivery arrival time as arrival time for a corresponding adjustment coordinate point, and sort the adjustment coordinate point according to a sequence of the arrival time, to generate an adjustment coordinate point list; compare arrival time for adjustment coordinate points in the adjustment coordinate point list with estimated arrival time for coordinate points in the to-be-adjusted path one by one; and set, if arrival time for an adjustment coordinate point is earlier than estimated arrival time for a coordinate point, the adjustment coordinate point to be a previous coordinate point of the coordinate point, adjust the estimated arrival time for the coordinate point and estimated arrival time for next coordinate points of the coordinate point according to the arrival time for the adjustment coordinate point, compare arrival time for next adjustment coordinate points of the adjustment coordinate point with the adjusted estimated arrival time for the coordinate point and the adjusted estimated arrival time for the next coordinate points of the coordinate point one by one until all adjustment coordinate points in the adjustment coordinate point list are set to be coordinate points in the to-be-adjusted path, and generate information for indicating an adjusted delivery path.

In some embodiments, when a given cluster contains at least two pieces of order information including the target delivery arrival time, the apparatus is further configured to: select earliest target delivery arrival time from the at least two pieces of order information, for use as arrival time for an adjustment coordinate point corresponding to the cluster to which the order information belongs.

In a third aspect, an embodiment of the present disclosure provides an electronic device, including: one or more processors; and a storage device, configured to store one or more programs, where the one or more programs, when executed by the one or more processors, cause the one or more processors to implement the method according to any embodiment in the first aspect.

In a fourth aspect, an embodiment of the present disclosure provides a computer readable storage medium, storing a computer program, where the computer program, when executed by a processor, implements the method according to any embodiment in the first aspect.

According to the method and apparatus for generating information provided in the embodiments, by acquiring the address information of to-be-delivered orders, the corresponding address coordinates may be ascertained, and thus, the orders are clustered according to the address coordinates to generate different clusters. Then, the center point coordinates matching the coordinates of the preset address and being an the clusters are used as the starting coordinates of the path, and the following path planning steps are performed: using the center point coordinates having the shortest distance from the starting coordinates and being in the remaining clusters as the second coordinates of the path, the remaining clusters referring to the clusters other than the cluster with the center point coordinates as the coordinates of the path in the clusters; determining whether the number of the remaining clusters reaches the preset threshold; if the determination result is yes, generating the information for indicating the delivery path; and if the determination result is no, using the second coordinates as the starting coordinates, and continuing the above path planning steps. This may make the planned delivery route more better, which helps to improve the delivery efficiency.

### BRIEF DESCRIPTION OF THE DRAWINGS

After reading detailed descriptions of non-limiting embodiments given with reference to the following accompanying drawings, other features, objectives and advantages of the present disclosure will be more apparent.

FIG. 1 is a diagram of an exemplary system architecture in which the present disclosure may be applied;

FIG. 2 is a flowchart of an embodiment of a method for generating information according to the present disclosure;

FIG. 3 is a flowchart of another embodiment of the method for generating information according to the present disclosure;

FIG. 4 is a schematic diagram of an application scenario of the method for generating information according to the present disclosure;

FIG. 5 is a schematic structural diagram of an embodiment of an apparatus for generating information according to the present disclosure; and

FIG. 6 is a schematic structural diagram of a computer system adapted to implement an electronic device according to embodiments of the present disclosure.

### DETAILED DESCRIPTION OF EMBODIMENTS

### Description of Embodiments

The present disclosure will be further described below in detail in combination with the accompanying drawings and the embodiments. It may be appreciated that the specific embodiments described herein are merely used for explaining the relevant disclosure, rather than limiting the disclosure. In addition, it should also be noted that, for the ease of description, only the parts related to the relevant disclosure are shown in the accompanying drawings.

It should be noted that the embodiments in the present disclosure and the features in the embodiments may be combined with each other on a non-conflict basis. The present disclosure will be described below in detail with reference to the accompanying drawings and in combination with the embodiments.

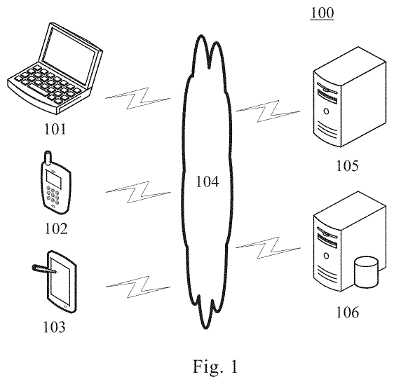

FIG. 1 illustrates an exemplary system architecture 100 of an embodiment in which a method and apparatus for generating information of the present disclosure may be applied.

As shown in FIG. 1, the system architecture 100 may include terminals 101, 102, 103, a network 104, a server 105, and database server 106. The network 104 is used to provide a communication link medium between the terminals 101, 102, 103, the server 105 and the database server 106. The network 104 may include various types of connections, such as wired, wireless communication links, or optic fibers.

A user may interact with the server 105 and database server 106 through the network 104 using the terminals 101, 102, 103, to receive or send messages and the like. Various communication client applications, such as shopping applications, web browser applications, order delivery application, and map application, may be installed on the terminals 101, 102, and 103.

The terminals 101, 102, 103 may be various electronic devices having a display screen, including but not limited to smart phones, tablet PCs, e-book readers, laptop portable computers and desktop computers, and the like.

The database server 106 may be a server that provides various services, for example, the database server 106 may store address code files and to-be-delivered order information. The address code file may include a program for calculating an address code of the address information.

The server 105 may also be a server that provides various services, such as a backend server that supports various applications displayed on the terminals 101, 102, and 103. The backend server may perform processing such as analysis on the address code file and the to-be-delivered order information obtained from the database server 106, and may send the processing result (for example, information used to indicate the delivery path) to the terminals 101, 102, and 103. In this way, the user may perform order delivery according to the delivery path displayed by the terminals 101, 102, and 103.

It should be noted that the method for generating information provided by the embodiments of the present disclosure is generally performed by the server 105. Accordingly, the apparatus for generating information is generally provided in the server 105.

It should be noted that when the server 105 has the function of the database server 106, the system architecture 100 may not be provided with the database server 106.

It should be understood that the number of terminals, networks, and servers in FIG. 1 is merely illustrative. Depending on the implementation needs, there may be any number of terminal devices, networks, and servers.

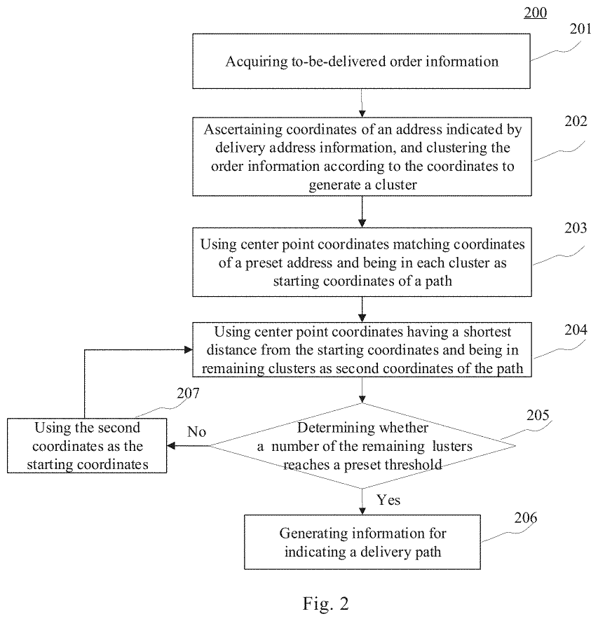

Further referring to FIG. 2, FIG. 2 illustrates a flow 200 of an embodiment of a method for generating information according to the present disclosure. The method for generating information in this embodiment, includes the following steps.

Step 201, acquiring to-be-delivered order information.

In this embodiment, an electronic device (e.g., the server 105 shown in FIG. 1) on which the method for generating information runs may acquire the to-be-delivered order information by various means. As an example, the electronic device may acquire the order information from a database server (e.g., the database server 106 shown in FIG. 1) with which the electronic device is communicated by means of a wired connection or a wireless connection. As another example, the electronic device may provide support to a shopping application on a terminal (e.g., the terminals 101, 102 and 103 shown in FIG. 1). In this way, when a user places an order through the terminal, the electronic device may store the order information, and thus, may locally acquire the order information. Here, the order information may include delivery address information. The delivery address information is generally information for indicating a delivery destination, and may include characters such as numbers, letters and words. For example, the delivery address information may be **Community, **District, **City.

Step 202, ascertaining coordinates of an address indicated by the delivery address information, and clustering the order information according to the coordinates to generate a cluster.

In this embodiment, the electronic device may ascertain the coordinates of the address indicated by the delivery address information according to the delivery address information acquired in step 201. Here, the coordinates generally refer to longitude and latitude coordinates. Then, the electronic device may calculate the distance between the addresses indicated by any two pieces of delivery address information according to the values of the coordinates. According to the distance between the addresses, the order information may be clustered to generate at least one cluster. It should be noted that a parameter (e.g., the distance threshold) for the clustering may be set according to actual requirements.

As an example, the distance between the addresses may be a straight line distance between the two addresses. If the longitude and latitude coordinates of A address are (a, b) and the longitude and latitude coordinates of B address are (c, d), the distance between the A address and the B address is \sqrt{(a−c)²+(b−d)²}.

Alternatively, the distance between the addresses may also be the sum of the absolute value of the longitude coordinate difference between the coordinates of the two addresses, and the absolute value of the latitude coordinate difference between the coordinates of the two addresses. If the longitude and latitude coordinates of the A address are (a, b) and the longitude and latitude coordinates of the B address are (c, d), the distance between the A address and the B address is |a−c|+|b−d|. It may be appreciated that a delivery person tends not to travel along the straight line distance between the two addresses during the delivery. That is, the travel route is usually a bend line. Therefore, using this method to calculate the distance between the two addresses is more in line with the actual situation.

In some alternative implementations of this embodiment, the electronic device may ascertain the coordinates of the address indicated by the delivery address information through a map application. The electronic device inputs the delivery address information into the map application for searching, thereby obtaining the longitude and latitude coordinates of the address indicated by the delivery address information.

Alternatively, the electronic device may perform an address code calculation on the delivery address information according to an address code file to obtain an address code of the address indicated by the delivery address information, and then may ascertain the longitude and latitude coordinates of the address code. The address code file may be stored locally in the electronic device, or may be stored on the database server, and the specific storage location is not limited.

Step 203, using center point coordinates in each cluster that match coordinates of a preset address as starting coordinates of a path.

In this embodiment, the electronic device may use the center point coordinates, which match the coordinates of the preset address, in the each cluster as the starting coordinates of the path. As an example, the electronic device may use the center point coordinates in the each cluster that are the same as the coordinates of the preset address as the starting coordinates of the path. As another example, the electronic device may use the center point coordinates in the each cluster that have a distance from the coordinates of the preset address meeting a preset threshold (e.g., 10 meters) as the starting coordinates of the path. That is, the center point coordinates located in the vicinity of the preset address may be used as the starting coordinates of the path. Here, the preset address may be any address, for example, the address of a delivery transfer station or the current address of a delivery person. After ascertaining the starting coordinates of the path, the electronic device may perform path planning steps in step 204-206.

It may be appreciated that if the center point coordinates of a certain cluster are the same as the coordinates of the preset address, or are located in the vicinity of the coordinates of the preset address, the addresses indicated by the other coordinates (except the center point coordinates) in the cluster are generally the addresses located in the vicinity of the preset address.

Step 204, using center point coordinates having a shortest distance from the starting coordinates and being in remaining clusters as second coordinates of the path.

In this embodiment, the electronic device may use the center point coordinates, which have the shortest distance from the starting coordinates, in the remaining clusters as the second coordinates of the path. Here, the remaining clusters are clusters other than a cluster with center point coordinates as coordinates of the path in all the clusters. The distance here may be the linear distance between the two pairs of coordinates, or may alternatively be the sum of the absolute value of the longitude difference between the two pairs of coordinates and the absolute value of the latitude difference between the two pairs of coordinates.

As an example, if the electronic device uses the center point coordinates of the cluster A in the clusters A, B, C, and D as the starting coordinates of the path, the electronic device may ascertain, in the remaining clusters (i.e., the clusters B, C, and D), the center point coordinates having the shortest distance from the starting coordinates (the center point coordinates of the cluster A), and use the coordinates having the shortest distance from the starting coordinates as the second coordinates of the path.

Step 205, determining whether a number of the remaining clusters reaches a preset threshold.

In this embodiment, after ascertaining a next pair of coordinates of the path each time, the electronic device may determine whether the number of the remaining clusters reaches the preset threshold. Here, the preset threshold is not limited in the present disclosure, for example, may be 0. If the number of the remaining clusters reaches the preset threshold, the electronic device may perform step 206. If the number of the remaining clusters does not reach the preset threshold, the electronic device may perform step 207.

It may be appreciated that if the number of the remaining clusters is 0, it indicates that the center point coordinates of all the clusters have been used as the coordinates of the path. That is, it is possible to complete the delivery tasks for all the to-be-delivered orders through the path.

Step 206, generating, in response to a determination result being yes, information for indicating a delivery path.

In this embodiment, the determination result of the electronic device in step 205 is yes, that is, the number of the remaining clusters reaches the preset threshold, the information for indicating the delivery path In may be generated. The delivery path may be used to describe the sequence in which the delivery person passes through the coordinates (the center point coordinates of the clusters). Here, the end point coordinates in the delivery path may be the same as the starting coordinates, that is, the delivery path is a round-trip route. The end point coordinates in the delivery path may alternatively be different from the starting coordinates, that is, the delivery path is a one-way route. Here, the information for indicating the delivery path may not only include the coordinate point indicated by each pair of coordinates of the delivery path, but also include the order information in the cluster corresponding to each coordinate point.

It may be appreciated that, after the order information is clustered through the coordinates, the orders having adjacent delivery addresses may be clustered into the same cluster. In this way, for each coordinate point of the delivery path, the delivery person may complete the delivery for all the orders at this coordinate point which have adjacent delivery addresses, and then travel to the next coordinate point of the delivery path, which avoids that the delivery efficiency is affected because the delivery person travels back and forth between two coordinate points due to unreasonable route planning or the omission of order information. In addition, for a specific delivery path for the each coordinate point of the delivery path, the delivery person may perform the planning by himself according to personal experience or habits. Since the delivery addresses of the same coordinate point are adjacent, the effect on the delivery efficiency is relatively small. Moreover, the number of the orders corresponding to the each coordinate point is also much smaller than the total number of the to-be-delivered orders, which helps the delivery person to quickly plan a specific delivery path, thereby improving delivery efficiency.

Step 207, using, in response to a determination result being no, the second coordinates as the starting coordinates, and performing the path planning steps.

In this embodiment, if the determination result of the electronic device in step 205 is no, that is, the number of the remaining clusters does not reach the preset threshold, the second coordinates may be used as the starting coordinates, and the path planning steps in steps 204-206 may be continued. For example, if the number of the remaining clusters is not 0, it indicates that the coordinates in the path do not include the center point coordinates of the remaining clusters, that is, the planning for the path has not been completed.

In some alternative implementations of this embodiment, when there are at least two clusters having the shortest distance from the starting coordinates in the remaining clusters, the electronic device may further use the center point coordinates of the at least two clusters as the second coordinates of the path, respectively, and perform the above path planning steps to generate at least two pieces of information for indicating a candidate delivery path. Information is selected from the at least two pieces of information for indicating the candidate delivery path, to be used as the information for indicating the delivery path. The selection here may be a random selection, or a selection for a candidate delivery path having a minimum total length.

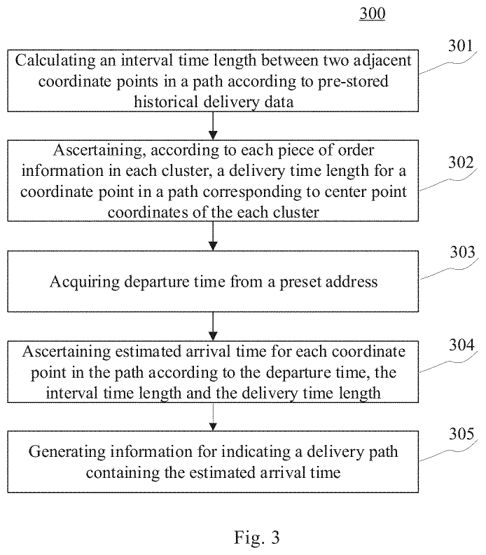

Further, the method for generating information in the present disclosure may further ascertain estimated arrival time of each coordinate point in the delivery path, to generate information for indicating the delivery path containing the estimated arrival time. For details, reference may be made to the related description in the embodiment shown in FIG. 3, and the details will not be repeatedly described here.

According to the method for generating information provided in this embodiment, by acquiring the address information of to-be-delivered orders, the corresponding address coordinates may be ascertained, and thus, the orders are clustered according to the address coordinates to generate different clusters. Then, the center point coordinates matching the coordinates of the preset address and being in the clusters are used as the starting coordinates of the path, and the following path planning steps are performed: using the center point coordinates having the shortest distance from the starting coordinates and being in the remaining clusters as the second coordinates of the path, the remaining clusters referring to the clusters other than the cluster with the center point coordinates as the coordinates of the path in the clusters; determining whether the number of the remaining clusters reaches the preset threshold; if the determination result is yes, generating the information for indicating the delivery path; and if the determination result is no, using the second coordinates as the starting coordinates, and continuing the above path planning steps. This may make the planned delivery route more better, which helps to improve the delivery efficiency.

Further referring to FIG. 3, FIG. 3 illustrates a flow 300 of another embodiment of the method for generating information provided in the present disclosure. In addition to the steps in the flow 200, the flow 300 may further include the following steps.

Step 301, calculating an interval time length between two adjacent coordinate points in a path according to pre-stored historical delivery data.

In this embodiment, an electronic device (e.g., the server 105 shown in FIG. 1) on which the method for generating information runs may calculate the interval time length between the two adjacent coordinate points in the delivery path in the generated information according to the pre-stored historical delivery data. Here, the historical delivery data may include coordinate information collected during a delivery and the time at which the coordinate information is collected. Here, the historical delivery data may be locally stored in the electronic device, or may be stored in a terminal (e.g., the terminals 101, 102 and 103 shown in FIG. 1) or a database server (e.g., the database server 106 shown in FIG. 1).

For example, during the delivery for an order, a terminal used by a delivery person may collect the coordinate information of the current location (the delivery address or near the delivery address) of the delivery person using a positioning function, and record the time at which the coordinate information is collected. In this way, an average historical interval time length between the two collected coordinate points may be calculated through a statistical analysis. Therefore, the average historical interval time length between the two collected coordinate points, which are respectively the same as the two adjacent coordinate points in the delivery path, may be used as the interval time length between the two adjacent coordinate points in the delivery path. Thus, the use of the historical delivery data helps to improve the estimation accuracy for the interval time length.

It should be noted that, for a new delivery address, due to the lack of relevant data in the historical delivery data, the electronic device may ascertain the interval time length between the two coordinate points according to the distance between the two coordinate points and a preset travel speed.

Step 302, ascertaining, according to each piece of order information in each cluster, a delivery time length for a coordinate point in a path corresponding to center point coordinates of the each cluster.

In this embodiment, the order information may further include at least one of: commodity information, transaction information or delivery approach information. At this point, the electronic device may first ascertain the total order information of the each cluster according to the each piece of order information in the each cluster. Then, the delivery time length for the coordinate point in the path corresponding to the center point coordinates of the each cluster may be ascertained according to the total order information of the each cluster.

In this embodiment, the commodity information may include, but not limited to, at least one of: a weight of a commodity, a dimension of the commodity, a number of commodities, or the like. The transaction information may include whether the order has been paid and a payment approach of payment on delivery (e.g., cash transaction or online transaction). The delivery approach may include a delivery to an express cabinet, a delivery to a mailroom, a delivery to the house of an addressee or the like. It may be appreciated that if the number of the commodities is large, the number of packages may be increased, which increases the number of times that the delivery personnel transports the commodities. If the commodity is heavy or bulky, it is not convenient to transport it. All this will increase the delivery time length. Since the delivery for an order for payment on delivery further includes a payment procedure, this delivery often consumes more time than the delivery for a paid order. Moreover, different payments on delivery and different delivery approaches take different delivery time lengths. The delivery will be more in line with the actual delivery situations in consideration of these factors, which may help to improve the accuracy of the calculated delivery time length.

Here, the required order information may be selected according to actual situations, and a corresponding weight value may be set, to calculate the delivery time length for each coordinate point in the path. As an example, model training may also be performed using a large amount of historical delivery order information, to obtain a delivery time length estimation model. In this way, after the order information in the each cluster is inputted to the delivery time length estimation model, the delivery time length for the each coordinate point in the path corresponding to the center point coordinates of the each cluster may be estimated, that is, the total time that may be consumed by the delivery person on the coordinate point.

Step 303, acquiring departure time from a preset address.

In this embodiment, the electronic device may acquire the departure time from the preset address in various ways. For example, when performing positioning using the terminal used by the delivery person or other positioning methods and finding that the delivery person departs from the preset address, the electronic device may record the current time and use the time as the departure time from the preset address. As another example, the above departure time from the preset address may be sent by the terminal to the electronic device. The triggering method of the sending may refer to that the departure time is sent when the delivery person touches a certain key on the terminal, or the departure time is sent after the terminal performing the positioning and finds that the current location is far from the preset address. It should be noted that the above departure time may be the current time or preset time.

Step 304, ascertaining estimated arrival time for each coordinate point in the path according to the departure time, the interval time length and the delivery time length.

In this embodiment, the electronic device may ascertain the estimated arrival time for the each coordinate point in the path according to the departure time acquired in step 303, the interval time length in step 301 and the delivery time length in step 302. The estimated arrival time for the each coordinate point mainly refers to the sum of the estimated arrival time and the delivery time length for the previous coordinate point of the coordinate point and the interval time length between the coordinate point and the previous coordinate point. The estimated arrival time for a second coordinate point in the path refers to the sum of the departure time from the starting coordinate point (the preset address) and the interval time length between the starting coordinate point and the second coordinate point.

Step 305, generating information for indicating a delivery path containing the estimated arrival time.

In this embodiment, the electronic device may generate the information for indicating the delivery path containing the estimated arrival time, according to the information for indicating the delivery path that is generated in the embodiment of FIG. 2 and the estimated arrival time for the each coordinate point in the path that is ascertained in step 304.

In some alternative implementations of this embodiment, the order information may further include target delivery arrival time, for example, delivery arrival time specified by the user at the time of placing the order. At this point, the electronic device may further perform the following adjustments.

(1) A coordinate point in a path corresponding to a cluster to which order information including the target delivery arrival time belongs is ascertained as an adjustment coordinate point.

For example, the coordinate point in the path refers to a first (starting) coordinate point A in the path corresponding to the cluster to which order information A1 and A2 belong, a second coordinate point B in the path corresponding to the cluster to which order information B1 and B2 belong, a third coordinate point C in the path corresponding to the cluster to which order information C1 and C2 belong, and a fourth coordinate point D in the path corresponding to the cluster to which order information D1 and D2 belong. If both the order information B1 and the order information D1 include the target delivery arrival time (e.g., 11:00 a.m. and 10:00 a.m. on the same day, respectively), the electronic device may use the coordinate points B and D as the adjustment coordinate points.

(2) Information of the adjustment coordinate point in the information for indicating the delivery path containing the estimated arrival time is deleted, and a to-be-adjusted path is generated.

For example, for the example in (1), the electronic device may delete the information of the adjustment coordinate points B and D in the information for indicating the delivery paths (the coordinate points A, B, C and D in sequence) containing the estimated arrival time, and generate the to-be-adjusted paths (i.e., the coordinate points A and C in sequence).

(3) The target delivery arrival time is used as the arrival time for the corresponding adjustment coordinate point, and the adjustment coordinate point is sorted according to the sequence of the arrival time, to generate an adjustment coordinate point list. Here, a corresponding relationship between the adjustment coordinate point and the arrival time may be stored in the adjustment coordinate point list.

For example, for the example in (1), the electronic device may use the target delivery arrival time 11:00 as the arrival time for the adjustment coordinate point B, and use the target delivery arrival time 10:00 as the arrival time for the adjustment coordinate point D. Since the arrival time for the coordinate point D is earlier than the arrival time for the coordinate point B, in the generated adjustment coordinate point list, the coordinate point D is located before the coordinate point B.

(4) The arrival time for the adjustment coordinate points in the adjustment coordinate point list is compared with the estimated arrival time for the coordinate points in the to-be-adjusted path one by one. If the arrival time for an adjustment coordinate point is earlier than the estimated arrival time for a coordinate point, the adjustment coordinate point is set to be a previous coordinate point of the coordinate point, and the estimated arrival time for the coordinate point and estimated arrival time for next coordinate points of the coordinate point are adjusted according to the arrival time for the adjustment coordinate point. Arrival time for next adjustment coordinate points of the adjustment coordinate point is compared with the adjusted estimated arrival time for the coordinate point and the adjusted estimated arrival time for the next coordinate points of the coordinate point one by one until all the adjustment coordinate points in the adjustment coordinate point list are set to be coordinate points in the to-be-adjusted path, and information for indicating an adjusted delivery path is generated.

For example, for the example in (1), the electronic device may first compare the arrival time for the adjustment coordinate point D in the adjustment coordinate point list with the estimated arrival time for the coordinate point A and the coordinate point D in the to-be-adjusted path one by one. It should be noted that when the to-be-adjusted path contains the coordinate point (i.e., the starting coordinate point) corresponding to the preset address, for example, the coordinate point A, since the estimated arrival time for the coordinate point A is the departure time (e.g., 8:00), the electronic device may compare the arrival time for the adjustment coordinate points in the adjustment coordinate point list with the estimated arrival time for the next coordinate points of the starting coordinate point in the to-be-adjusted path one by one. That is, the electronic device may directly compare the arrival time for the adjustment coordinate point D with the estimated arrival time for the coordinate point C, which helps to improve the processing efficiency.

It is assumed that the estimated arrival time for the coordinate point C is 10:30. Since 10:00 is earlier than 10:30, the electronic device may use adjustment coordinate point D as the previous coordinate point of the coordinate point C in the to-be-adjusted path. At this point, the sequence of the coordinate points in the to-be-adjusted path is sequentially the coordinate point A, the coordinate point D and the coordinate point C. In addition, the estimated arrival time for the coordinate point C is adjusted (e.g., 10:40) according to the arrival time for the adjustment coordinate point D, the delivery time length, and the interval time length between the adjustment coordinate point D and the coordinate point C. Then, since 11:00 is later than 10:00, in order to further improve the processing efficiency, the electronic device may directly compare the arrival time for the adjustment coordinate point B with the adjusted estimated arrival time for the coordinate point C. Since 11:00 is later than 10:40, the electronic device may use the adjustment coordinate point B as the next coordinate point of the coordinate point C in the to-be-adjusted path. At this point, the sequence of the coordinate points in the to-be-adjusted path is sequentially the coordinate point A, the coordinate point D, the coordinate point C and the coordinate point B. In this way, the electronic device may generate the information for indicating the adjusted delivery path (the coordinate points A, D, C and B in sequence), and the information contains the estimated arrival time for each coordinate point in the adjusted delivery path (8:00, 10:00, 10:40, and 11:00 in sequence).

It should be noted that when a given cluster contains at least two pieces of order information including the target delivery arrival time, the electronic device may select earliest target delivery arrival time from the at least two pieces of order information, and use the earliest target delivery arrival time as arrival time for an adjustment coordinate point corresponding to the cluster to which the order information belongs.

For example, for the example in (1), the target delivery arrival time for the order information B1 and the target delivery arrival time for the order information B2 are respectively 11:00 and 12:00, the arrival time for the adjustment coordinate point B may be the earlier target delivery arrival time 11:00.

Alternatively, the electronic device may further send the estimated arrival time for the each coordinate point to the user corresponding to the order information in the corresponding cluster. Alternatively, the estimated arrival time for the each coordinate point may be updated into the logistics information of the order information in the corresponding cluster. In this way, the user placing an order may be made aware of the possible delivery time (i.e., the estimated arrival time) of the order, thereby improving the user experience.

As compared with the embodiment corresponding to FIG. 2, according to the method for generating information provided in this embodiment, the information for indicating the delivery path may be generated to optimize the planning for the delivery path, thereby improving the delivery efficiency. In addition, the information may further include the estimated arrival time for the each coordinate point in the delivery path. At the same time, the set delivery arrival time (the target delivery arrival time) is also taken into consideration in the estimation for the delivery arrival time, and thus, the route and the time are both taken into consideration. Therefore, the accuracy of the delivery arrival time is improved, and the user experience is improved.

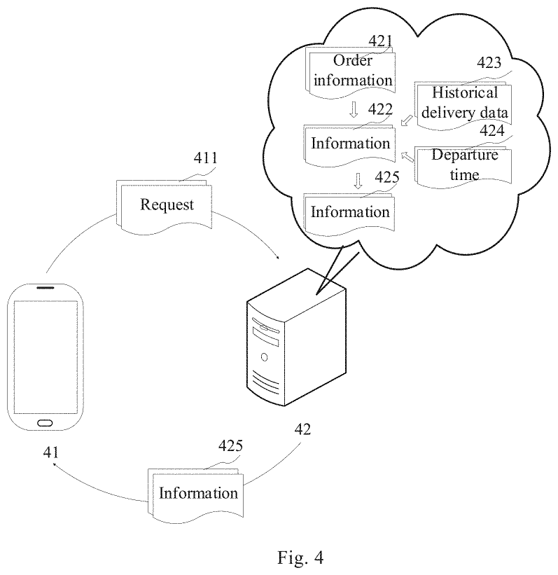

Further referring to FIG. 4, FIG. 4 is a schematic diagram of an application scenario of the method for processing information according to the embodiment of FIG. 2 and the embodiment of FIG. 3. In the application scenario of FIG. 4, the delivery person may send a delivery path generation request 411 using a terminal 41 used by the delivery person. After receiving the delivery path generation request 411 sent by the terminal 41, a server 42 may first acquire all to-be-delivered order information 421 of the delivery person, to perform clustering according to the coordinates of an address indicated by delivery address information. Then, the center point coordinates matching coordinates of a preset address and being in each cluster are used as the starting coordinates of a path, and path planning steps are performed to generate information for indicating a delivery path. Next, the server 42 may respectively ascertain an interval time length between two adjacent coordinate points in the path and a delivery time length for each coordinate point according to historical delivery data 423 and the order information 421. Then, the estimated arrival time for the each coordinate point in the path may be ascertained according to the departure time 424 from the preset address. Finally, the server 42 may generate information 425 for indicating a delivery path containing the estimated arrival time, and send the information 425 to the terminal 41. In this way, the delivery person may deliver the order according to the information displayed on the terminal 41.

Further referring to FIG. 5, as an implementation of the method shown in the above drawings, the present disclosure provides an embodiment of an apparatus for generating information. The embodiment of the apparatus corresponds to the embodiment of the method shown in FIG. 2, and the apparatus may be applied in various electronic devices.

As shown in FIG. 5, the apparatus 500 for generating information in this embodiment may include: a first acquiring unit 501, configured to acquire to-be-delivered order information, the order information including delivery address information; a clustering unit 502, configured to ascertain coordinates of an address indicated by the delivery address information, and cluster the order information according to the coordinates to generate a cluster; a first performing unit 503, configured to use center point coordinates matching coordinates of a preset address and being in each cluster as starting coordinates of a path, and perform following path planning steps: using center point coordinates having a shortest distance from the starting coordinates and being in remaining clusters as second coordinates of the path, the remaining clusters referring to clusters other than a cluster with center point coordinates as coordinates of the path in all clusters; determining whether a number of the remaining clusters reaches a preset threshold; and generating, in response to a determination result being yes, information for indicating a delivery path; and a responding unit 504, configured to use, in response to the determination result being no, the second coordinates as the starting coordinates, and perform the path planning steps.

In this embodiment, for specific processes of the first acquiring unit 501, the clustering unit 502, the first performing unit 503 and the responding unit 504, and their technical effects, reference may be made to relative descriptions of step 201, step 202, steps 203-206 and step 207 in the embodiment shown in FIG. 2 respectively, which will not be repeatedly described here.

In some alternative implementations of this embodiment, the above coordinates may refer to longitude and latitude coordinates. At this point, the clustering unit 502 may be further configured to: cluster the order information according to a distance between two pairs of coordinates, the distance being a sum of an absolute value of a longitude coordinate difference between the two pairs of coordinates, and an absolute value of a latitude coordinate difference between the two pairs of coordinates.

Alternatively, when there are at least two clusters having the shortest distance from the starting coordinates in the remaining clusters, the apparatus may further include: a second performing unit (not shown in the figures), configured to respectively use center point coordinates of the at least two clusters as the second coordinates of the path, and perform the path planning steps, to generate at least two pieces of information for indicating a candidate delivery path; and a selecting unit (not shown in the figures), configured to select information from the at least two pieces of information for indicating the candidate delivery path, to use the information as the information for indicating the delivery path.

Further, the apparatus 500 may further include: a first calculating unit (not shown in the figures), configured to calculate an interval time length between two adjacent coordinate points in the path according to pre-stored historical delivery data, the historical delivery data including coordinate information collected during a delivery and time at which the coordinate information is collected.

Alternatively, the order information may further include at least one of: commodity information, transaction information or delivery method information. The apparatus 500 may further include: a second calculating unit (not shown in the figures), configured to ascertain total order information of the each cluster according to each piece of order information in the each cluster; and a third calculating unit (not shown in the figures), configured to ascertain a delivery time length for a coordinate point in a path corresponding to center point coordinates of the each cluster, according to the total order information of the each cluster.

As an example, the apparatus 500 may further be configured to: acquire departure time from the preset address; ascertain estimated arrival time for each coordinate point in the path according to the departure time, the interval time length and the delivery time length; and generate information for indicating a delivery path containing the estimated arrival time.

In some application scenarios, the order information may further include target delivery arrival time. The apparatus 500 may further be configured to: ascertain a coordinate point in a path corresponding to a cluster to which order information including the target delivery arrival time belongs as an adjustment coordinate point; delete information of the adjustment coordinate point in the information for indicating the delivery path containing the estimated arrival time, and generate a to-be-adjusted path; use the target delivery arrival time as arrival time for a corresponding adjustment coordinate point, and sort the adjustment coordinate point according to a sequence of the arrival time, to generate an adjustment coordinate point list; compare arrival time for adjustment coordinate points in the adjustment coordinate point list with estimated arrival time for coordinate points in the to-be-adjusted path one by one; and set, if arrival time for an adjustment coordinate point is earlier than estimated arrival time for a coordinate point, the adjustment coordinate point to be a previous coordinate point of the coordinate point, adjust the estimated arrival time for the coordinate point and estimated arrival time for next coordinate points of the coordinate point according to the arrival time for the adjustment coordinate point, compare arrival time for next adjustment coordinate points of the adjustment coordinate point with the adjusted estimated arrival time for the coordinate point and the adjusted estimated arrival time for the next coordinate points of the coordinate point one by one until all adjustment coordinate points in the adjustment coordinate point list are set to be coordinate points in the to-be-adjusted path, and generate information for indicating an adjusted delivery path.

Alternatively, when a given cluster contains at least two pieces of order information including the target delivery arrival time, the apparatus 500 may be further configured to: select earliest target delivery arrival time from the at least two pieces of order information, for use as arrival time for an adjustment coordinate point corresponding to the cluster to which the order information belongs.

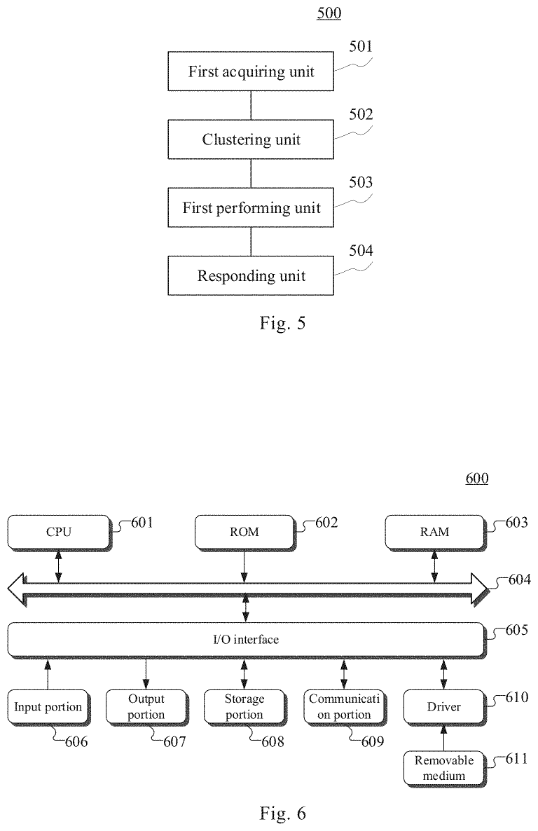

With reference to FIG. 6, which illustrates a schematic structural diagram of a computer system 600 adapted to implement an electronic device according to an embodiment of the present application. The electronic device shown in FIG. 6 is only an example, and should not impose any limitation on the functions and scope of use of the embodiments of the present application.

As shown in FIG. 6, the computer system 600 includes a central processing unit (CPU) 601, which may execute various appropriate actions and processes in accordance with a program stored in a read-only memory (ROM) 602 or a program loaded into a random access memory (RAM) 603 from a storage portion 708. The RAM 603 also stores various programs and data required by operations of the system 600. The CPU 601, the ROM 602 and the RAM 603 are connected to each other through a bus 604. An input/output (I/O) interface 605 is also connected to the bus 604.

The following components are connected to the I/C) interface 605: an input portion 606 including a keyboard, a mouse, or the like; an output portion 607 including a cathode ray tube (CRT), a liquid crystal display device (LCD), a speaker, or the like; a storage portion 608 including a hard disk, or the like; and a communication portion 609 including a network interface card, such as a LAN card and a modem. The communication portion 609 performs communication processes via a network, such as the Internet. A driver 610 is also connected to the I/O interface 605 as required. A removable medium 611, such as a magnetic disk, an optical disk, a magneto-optical disk, and a semiconductor memory, may be installed on the driver 610 as required, such that a computer program read therefrom is installed in the storage portion 608 as needed.

In particular, according to embodiments of the present disclosure, the process described above with reference to the flow chart may be implemented in a computer software program. For example, an embodiment of the present disclosure includes a computer program product, which includes a computer program that is tangibly embedded in a machine-readable medium. The computer program includes program codes for executing the method as illustrated in the flow chart. In such an embodiment, the computer program may be downloaded and installed from a network via the communication portion 609, and/or may be installed from the removable media 611. The computer program, when executed by the CPU 601, implements the functions as defined by the methods of the present disclosure. It should be noted that the computer readable medium in the present disclosure may be computer readable signal medium or computer readable storage medium or any combination of the above two. An example of the computer readable storage medium may include, but not limited to: electric, magnetic, optical, electromagnetic, infrared, or semiconductor systems, apparatus, elements, or a combination of any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fibre, a portable compact disk read only memory (CD-ROM), an optical memory, a magnet memory or any suitable combination of the above. In the present disclosure, the computer readable storage medium may be any tangible medium containing or storing programs which may be used by a command execution system, apparatus or element or incorporated thereto. In the present disclosure, the computer readable signal medium may include data signal in the base band or propagating as parts of a carrier, in which computer readable program codes are carried. The propagating data signal may take various forms, including but not limited to: an electromagnetic signal, an optical signal or any suitable combination of the above. The signal medium that can be read by computer may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion including one or more executable instructions for implementing specified logical functions. It should be further noted that, in some alternative implementations, the functions denoted by the blocks may also occur in a sequence different from the sequences shown in the figures. For example, any two blocks presented in succession may be executed substantially in parallel, or they may sometimes be executed in a reverse sequence, depending on the functions involved. It should be further noted that each block in the block diagrams and/or flow charts as well as a combination of blocks in the block diagrams and/or flow charts may be implemented using a dedicated hardware-based system executing specified functions or operations, or by a combination of dedicated hardware and computer instructions.

The units involved in the embodiments of the present disclosure may be implemented by means of software or hardware. The described units may also be provided in a processor, for example, may be described as: a first acquiring unit, a clustering unit, a first performing unit, and a responding unit. Here, the names of these units do not in some cases constitute limitations to such units themselves. For example, the first acquiring unit may also be described as “a unit configured to acquire to-be-delivered order information.”

In another aspect, the present disclosure further provides a computer readable medium. The computer readable medium may be included in the apparatus in the above described embodiments, or a stand-alone computer readable medium not assembled into the apparatus. The computer readable medium stores one or more programs. The one or more programs, when executed by the apparatus, cause the apparatus to: acquire to-be-delivered order information, the order information including delivery address information; ascertain coordinates an address indicated by the delivry address information, and cluster the order information according to the coordinates to generate a cluster; use center point coordinates matching coordinates of a preset address and being in each cluster as starting coordinates of a path, and perform following path planning: using center point coordinates having a shortest distance from the starting coordinates and being in remaining clusters as second coordinates of the path, the remaining clusters referring to clusters other than a cluster with center point coordinates as coordinates of the path in all clusters; determining whether a number of the remaining clusters reaches a preset threshold; and generating, in response to a determination result being yes, information for indicating a delivery path; and use, in response to the determination result being no, the second coordinates as the starting coordinates, and perform the path planning.

The above description only provides explanation of the preferred embodiments and the employed technical principles of the present disclosure. It should be appreciated by those skilled in the art that the inventive scope of the present disclosure is not limited to the technical solutions formed by the particular combinations of the above-described technical features. The inventive scope should also cover other technical solutions formed by any combination of the above-described technical features or equivalent features thereof without departing from the inventive concept of the present disclosure, for example, technical solutions formed by interchanging the above-described features with but not limited to, technical features with similar functions disclosed in the present disclosure.

1. A method for generating information, comprising:
acquiring to-be-delivered order information, the order information including delivery address information;
ascertaining coordinates of an address indicated by the delivery address information, and clustering the order information according to the coordinates to generate a cluster;
using center point coordinates matching coordinates of a preset address and being in each cluster as starting coordinates of a path, and performing following path planning: using center point coordinates having a shortest distance from the starting coordinates and being in remaining clusters as second coordinates of the path, the remaining clusters referring to clusters other than a cluster with center point coordinates as coordinates of the path in all clusters; determining whether a number of the remaining clusters reaches a preset threshold; and generating, in response to a determination result being yes, information for indicating a delivery path; and
using, in response to the determination result being no, the second coordinates as the starting coordinates, and performing the path planning.

2. The method according to claim 1, wherein the coordinates refer to longitude and latitude coordinates, and
the clustering the order information according to the coordinates comprises:
clustering the order information according to a distance between two pairs of coordinates, the distance being a sum of an absolute value of a longitude coordinate difference between the two pairs of coordinates, and an absolute value of a latitude coordinate difference between the two pairs of coordinates.

3. The method according to claim 1, wherein when there are at least two clusters having the shortest distance from the starting coordinates in the remaining clusters, the method further comprises:
using respectively center point coordinates of the at least two clusters as the second coordinates of the path, and performing the path planning, to generate at least two pieces of information for indicating a candidate delivery path; and
selecting information from the at least two pieces of information for indicating the candidate delivery path, for use as the information for indicating the delivery path.

4. The method according to claim 1, further comprising:
calculating an interval time length between two adjacent coordinate points in the path according to pre-stored historical delivery data, the historical delivery data including coordinate information collected during a delivery and time at which the coordinate information is collected.

5. The method according to claim 4, wherein the order information further comprises at least one of: commodity information, transaction information or delivery approach information, and
the method further comprises:
ascertaining total order information of the each cluster according to each piece of order information in each cluster: and
ascertaining a delivery time length for a coordinate point in a path corresponding to center point coordinates of the each cluster, according to the total order information of the each cluster.

6. The method according to claim 5, further comprising:
acquiring departure time from the preset address;
ascertaining estimated arrival time for each coordinate point in the path according to the departure time, the interval time length and the delivery time length; and
generating information for indicating a delivery path containing the estimated arrival time.

7. The method according to claim 6, wherein the order information further comprises target delivery arrival time, and
the method further comprises:
ascertaining a coordinate point in a path corresponding to a cluster to which order information including the target delivery arrival time belongs as an adjustment coordinate point;
deleting information of the adjustment coordinate point in the information for indicating the delivery path containing the estimated arrival time, and generating a to-be-adjusted path;
using the target delivery arrival time as arrival time for a corresponding adjustment coordinate point, and sorting the adjustment coordinate point according to a sequence of the arrival time, to generate an adjustment coordinate point list;
comparing arrival time for adjustment coordinate points in the adjustment coordinate point list with estimated arrival time for coordinate points in the to-be-adjusted path one by one; and
setting, if arrival time for an adjustment coordinate point is earlier than estimated arrival time for a coordinate point, the adjustment coordinate point to be a previous coordinate point of the coordinate point, adjusting the estimated arrival time for the coordinate point and estimated arrival time for next coordinate points of the coordinate point according to the arrival time for the adjustment coordinate point, comparing arrival time for next adjustment coordinate points of the adjustment coordinate point with the adjusted estimated arrival time for the coordinate point and the adjusted estimated arrival time for the next coordinate points of the coordinate point one by one until all adjustment coordinate points in the adjustment coordinate point list are set to be coordinate points in the to-be-adjusted path, and generating information for indicating an adjusted delivery path.

8. The method according to claim 7, wherein when a given cluster contains at least two pieces of order information including the target delivery arrival time, the using the target delivery arrival time as arrival time for a corresponding adjustment coordinate point comprises:
selecting earliest target delivery arrival time from the at least two pieces of order information, for use as arrival time for an adjustment coordinate point corresponding to the cluster to which the order information belongs.

9. An apparatus for generating information, comprising:
at least one processor; and
a memory storing instructions, wherein the instructions when executed by the at least one processor, cause the at least one processor to perform operations, the operations comprising:
acquiring to-be-delivered order information, the order information including delivery address information; coordinates of an address
ascertaining coordinates of an address indicated by the delivery address information, and clustering the order information according to the coordinates to generate a cluster;
using center point coordinates matching coordinates of a preset address and being in each cluster as starting coordinates of a path, and performing following path planning: using center point coordinates having a shortest distance from the starting coordinates and being in remaining clusters as second coordinates of the path, the remaining clusters referring to clusters other than a cluster with center point coordinates as coordinates of the path in all clusters; determining whether a number of the remaining clusters reaches a preset threshold; and generating, in response to a determination result being yes, information for indicating a delivery path; and
using, in response to the determination result being no, the second coordinates as the starting coordinates, and perform the path planning.

10. The apparatus according to claim 9, wherein the coordinates refer to longitude and latitude coordinates, and
the clustering the order information according to the coordinates comprises:
clustering the order information according to a distance between two pairs of coordinates, the distance being a sum of an absolute value of a longitude coordinate difference between the two pairs of coordinates, and an absolute value of a latitude coordinate difference between the two pairs of coordinates.

11. (canceled)

12. A non-transitory computer readable storage medium, storing a computer program, wherein the computer program, when executed by a processor, implements the method according claim 1.

13. The apparatus according to claim 9, wherein when there are at least two clusters having the shortest distance from the starting coordinates in the remaining clusters, the operations further comprise:
using respectively center point coordinates of the at least two clusters as the second coordinates of the path, and performing the path planning, to generate at least two pieces of information for indicating a candidate delivery path; and
selecting information from the at least two pieces of information for indicating the candidate delivery path, for use as the information for indicating the delivery path.

14. The apparatus according to claim 9, wherein the operations further comprise:
calculating an interval time length between two adjacent coordinate points in the path according to pre-stored historical delivery data, the historical delivery data including coordinate information collected during a delivery and time at which the coordinate information is collected.

15. The apparatus according to claim 14, wherein the order information further comprises at least one of: commodity information, transaction information or delivery approach information, and
the operations further comprise:
ascertaining total order information of the each cluster according to each piece of order information in each cluster; and
ascertaining a delivery time length for a coordinate point in a path corresponding to center point coordinates of the each cluster, according to the total order information of the each cluster.

16. The apparatus according to claim 15, wherein the operations further comprise:
acquiring departure time from the preset address;
ascertaining estimated arrival time for each coordinate point in the path according to the departure time, the interval time length and the delivery time length; and
generating information for indicating a delivery path containing the estimated arrival time.

17. The apparatus according to claim 16, wherein the order information further comprises target delivery arrival time, and
the operations further comprise:
ascertaining a coordinate point in a path corresponding to a cluster to which order information including the target delivery arrival time belongs as an adjustment coordinate point;
deleting information of the adjustment coordinate point in the information for indicating the delivery path containing the estimated arrival time, and generating a to-be-adjusted path;
using the target delivery arrival time as arrival time for a corresponding adjustment coordinate point, and sorting the adjustment coordinate point according to a sequence of the arrival time, to generate an adjustment coordinate point list;
comparing arrival time for adjustment coordinate points in the adjustment coordinate point list with estimated arrival time for coordinate points in the to-be-adjusted path one by one; and
setting, if arrival time for an adjustment coordinate point is earlier than estimated arrival time for a coordinate point, the adjustment coordinate point to be a previous coordinate point of the coordinate point, adjusting the estimated arrival time for the coordinate point and estimated arrival time for next coordinate points of the coordinate point according to the arrival time for the adjustment coordinate point, comparing arrival time for next adjustment coordinate points of the adjustment coordinate point with the adjusted estimated arrival time for the coordinate point and the adjusted estimated arrival time for the next coordinate points of the coordinate point one by one until all adjustment coordinate points in the adjustment coordinate point list are set to be coordinate points in the to-be-adjusted path, and generating information for indicating an adjusted delivery path.

18. The apparatus according to claim 17, wherein when a given cluster contains at least two pieces of order information including the target delivery arrival time, the using the target delivery arrival time as arrival time for a corresponding adjustment coordinate point comprises:
selecting earliest target delivery arrival time from the at least two pieces of order information, for use as arrival time for an adjustment coordinate point corresponding to the cluster to which the order information belongs.
